(19) United States
(12) Patent Application Publication
(10) Pub. No.: US 2025/0382450 A1
(43) Pub. Date: Dec. 18, 2025

(54) Water-Soluble Film Comprising at Least One Poly(Vinyl Alcohol)

(71) Applicant: Reckitt Benckiser Finish B.V., Hoofddorp (NL)

(72) Inventors: Alias Younis AL-BAYATI, Heidelberg (DE); Sascha FUHRMANN, Heidelberg (DE); Pascal Joachim KOZIOL, Heidelberg (DE); Claudia SCHMAELZLE, Heidelberg (DE); Divya VARADHARAJAN, Heidelberg (DE); Nils WEDLER, Heidelberg (DE); Qingcai ZHAO, Heidelberg (DE)

(21) Appl. No.: 18/875,955

(22) PCT Filed: Jun. 22, 2023
(86) PCT No.: PCT/EP2023/066955

§ 371 Date: Dec. 17, 2024

(30) Foreign Application Priority Data
Jun. 29, 2022 (GB) 2209571.5

(51) Int. Cl. C08L 29/04; C08J 5/18; C11D 17/04

(52) U.S. Cl. CPC C08L 29/04; C08J 5/18; C11D 17/045; C08J 2329/04; C08J 2405/00; C08J 2429/04; C08L 2203/162; C08L 2205/025; C08L 2205/03; C08L 2205/06

(57) ABSTRACT

The present invention is related to a water-soluble film comprising at least one poly(vinyl alcohol) wherein said water-soluble film further comprises at least one inulin and/or one derivative thereof; wherein said inulin and/or said derivative thereof is a neutral uncharged molecule, a positively charged cationic molecule or a negatively charged anionic molecule.

The present invention is also related to a method for manufacturing of such an inventive water-soluble film.

Furthermore, the invention is related to a dishwashing, preferably an automatic dishwashing, water-soluble container wherein said water-soluble container is made of such an inventive water-soluble film; and wherein said water-soluble container is at least partially filled with a dishwashing, preferably an automatic dishwashing, detergent composition.

### FIELD OF THE INVENTION

The present invention relates to a water-soluble film comprising at least one poly(vinyl alcohol).

The present invention is also related to a method for manufacturing of such an inventive water-soluble film.

Furthermore, the invention is related to a dishwashing, preferably an automatic dishwashing, water-soluble container wherein said water-soluble container is made of such an inventive water-soluble film.

### BACKGROUND OF THE INVENTION

Current commercially available water-soluble films used for complex multichamber thermoforming processes, for example in the manufacture of water-soluble automatic dishwashing (ADW) capsules, are mainly produced via an aqueous solution cast process. This process enables a water content in the film of greater than 3% which, by acting as a plasticizer, provides elasticity to the film.

Additionally, in such cast solution processes polyvinyl alcohol-polycarboxylate-polyvinyl acetate copolymer resins can be used. These polymers provide more freedom in adjusting properties compared to poly(vinyl alcohol) homopolymers. However, these copolymers cannot be used in extrusion processes as they tend to decompose due to high melt temperatures. Moreover, the process also requires a high amount of energy needed to dissolve all solid materials and then to evaporate the water. Moreover, manufacturing facilities require vast space due to the drying step.

There are also water-soluble films available which are produced from blown extrusion processes. These films are mainly used for applications such as shrink-wrap as it is difficult to control the blown process in such a way that the required homogenous thickness needed for thermoforming can be achieved. Water-soluble films processed using blown extrusion are exposed to two to three thermal stress steps, namely blending the solids and liquids under high shear forces and compounding the material in an extruder, before the composition is melted to manufacture the film. A further difficulty and restriction of blown extrusion processes is that it is difficult to blend into the water-soluble film a high level of liquid plasticizer.

Currently, poly(vinyl alcohol) (PVOH) is still the most commonly used water-soluble detergent capsule film material. On one hand, certain grade PVOH has good dissolution and biodegradation profile, recognized as cold water-soluble and readily biodegradable, and therefore favored by many industries, incl. hard surface cleaning, laundry and dishwashing.

On the other hand, PVOH is a synthetical polymer sourced from petrol chemistry, and there is a large potential to increase sustainability of PVOH films.

In addition, the current PVOH only works as a water-soluble packaging material but brings neither further function nor performance benefits.

### OBJECTIVE OF THE PRESENT INVENTION

In view of the prior art, it was thus an object of the present invention to provide a water-soluble film comprising at least one poly(vinyl alcohol), which shall not exhibit the aforementioned shortcomings of the known prior art water-soluble films comprising at least one poly(vinyl alcohol).

In particular, it was an object of the present invention to provide a water-soluble film comprising at least one poly(vinyl alcohol), which shall be still able to be processed to manufacture a dishwashing, preferably an automatic dishwashing, water-soluble container; while at the same time the amount of incorporated biopolymers should be maximized.

Additionally, it was especially an object of the present invention to provide a water-soluble film comprising at least one poly(vinyl alcohol), wherein the amount of plasticizers, e.g. glycerin, can be minimized.

### SUMMARY OF THE INVENTION

These objects and also further objects which are not stated explicitly but are immediately derivable or discernible from the connections discussed herein by way of introduction are achieved by a water-soluble film having all features of claim 1. Appropriate modifications to the inventive water-soluble film are protected in dependent claims 2 to 10. Further, claim 11 relates to a method for manufacturing of such an inventive water-soluble film. Claim 12 relates to a dishwashing, preferably an automatic dishwashing, water-soluble container wherein said water-soluble container is made of such an inventive water-soluble film, while claims 13 and 14 are appropriate modifications thereof. Claim 15 relates to the use of such an inventive water-soluble film for manufacturing a dishwashing, preferably an automatic dishwashing, water-soluble container.

The present invention accordingly provides a water-soluble film comprising at least one poly(vinyl alcohol) wherein said water-soluble film further comprises at least one inulin and/or one derivative thereof; wherein said inulin and/or said derivative thereof is a neutral uncharged molecule, a positively charged cationic molecule or a negatively charged anionic molecule.

It is thus possible in an unforeseeable manner to provide a water-soluble film comprising at least one poly(vinyl alcohol), which does not exhibit the aforementioned shortcomings of the known prior art water-soluble films comprising at least one poly(vinyl alcohol).

In addition thereto, a water-soluble film comprising at least one poly(vinyl alcohol) is provided, which is still able to be processed to manufacture a dishwashing, preferably an automatic dishwashing, water-soluble container; while at the same time the amount of incorporated biopolymers can be maximized.

Additionally, a water-soluble film comprising at least one poly(vinyl alcohol) is provided, wherein the amount of plasticizers, e.g. glycerin, is reduced.

### BRIEF DESCRIPTION OF THE TABLES

Objects, features, and advantages of the present invention will also become apparent upon reading the following description in conjunction with the tables, in which:

Table 1 exhibits a comparison of comparative and inventive formulations.

Table 2 exhibits experimental results about the dissolution of PVOH films comprising an inulin or a derivative thereof.

Table 3 exhibits experimental results about the tensile properties of PVOH films comprising an inulin or a derivative thereof.

Table 4: exhibits experimental results about the sealing properties of PVOH films comprising an inulin or a derivative thereof.

Table 5: exhibits experimental results about the dissolution of PVOH films comprising an inulin or a derivative thereof.

### DETAILED DESCRIPTION OF THE INVENTION

As used herein, the term “derivative”, when applied to an inulin in accordance with the present invention, refers to an inulin molecule in which either at least one of the hydroxyl groups covalently bonded directly to a glucose ring or a fructose ring; or at least one of the hydroxyl group of the —CH₂OH moieties, which are covalently bonded directly to a glucose ring or a fructose ring; has been chemically reacted with another organic molecule.

Thereby, at least one of the hydroxyl groups of an inulin molecule has been reacted to a final —OR moiety in which the residue R can be uncharged, positively charged, or negatively charged.

In case of an uncharged residue R, the finally achieved inulin derivative is a neutral uncharged molecule.

In case of a positively charged residue R, the finally achieved inulin derivative is a positively charged cationic molecule.

In case of a negatively charged residue R, the finally achieved inulin derivative is a negatively charged anionic molecule.

Inulin derivatives can be hydroxypropyl trimonium inulin, carboxymethyl inulin, cyanoethyl inulin, 3-amino-3-oxopropyl inulin, carboxyethyl inulin, 3-hydroxyimino-3-aminopropyl-inulin, esterified inulins, etherified inulins, inulin carbamate, methylated inulin, reaction products of inulin and an amino acid, inulin carbonate, polycarboxylate inulin, oxidized inulins, reduced inulins, inulin phosphates, and inulin containing a quaternary ammonium group or a primary, secondary, or tertiary amine.

As used herein, the terms “wt %”, “% wt.”, “weight %”, and “% by weight” are synonyms to each other. All of these expressions are referring to a weight percentage of the respective component.

By the term “water-soluble container” as used herein, it is meant a container which at least partially dissolves in water or disperses in water at 20° C. within 10 minutes to allow for egress of the contents of the package into the surrounding water.

By “monodose”, it is meant that the product comprises one or more compositions in the quantity required for a single wash cycle of a machine dishwasher.

The thermoformed water-soluble film comprising poly(vinyl alcohol) may be rigid or flexible at room temperature.

Preferably, the poly(vinyl alcohol) film may be partially or fully alcoholised or hydrolysed, for example, it may be from 40 to 100%, preferably 70 to 92%, most preferably about 85% to about 92%, alcoholised or hydrolysed, poly(vinyl acetate) film. The degree of hydrolysis is known to influence the temperature at which the PVOH starts to dissolve in water. 88% hydrolysis corresponds to a film soluble in cold (i.e. room temperature of 20° C.) water, whereas 92% hydrolysis corresponds to a film soluble in warm water. The film may be cast, blown or extruded. It may further be unoriented, mono-axially oriented or bi-axially oriented.

In one embodiment, said water-soluble film further comprises at least one plasticizer, preferably glycerin.

The plasticizer may be selected from the group consisting of glycerin and derivatives thereof, a C2-C6 alkylene glycol and derivatives thereof, polyalkylene glycols, esters of carboxylic acids, and any two or more combinations thereof.

Examples of C2-C6 alkylene glycols suitable for use in the present invention include but are not limited to ethylene glycol, 1,2 propylene glycol, 1,3 propylene glycol, butylene glycol, pentylene glycol, and hexylene glycol. Examples of polyalkylene glycols include but are not limited to polyethylene glycol, and polypropylene glycol.

Examples of esters of carboxylic acids include but are not limited to esters of citric acid, malic acid, maleic acid or succinic acid.

It is commonly known that an increase of the plasticizer content to an amount of 20-35% by weight of the film improves the forming properties of the film. This is thought to be due to the plasticizer decreasing the glass transition temperature and therefore providing flexibility to the film.

The film may comprise more than one plasticizer. Preferably, the film may comprise a blend of plasticizers.

Preferably, the film comprises a blend of glycerin and 1,2 propylene glycol.

It was surprisingly discovered that when the film comprises more than one plasticizer, particularly a blend of glycerin and an alkylene glycol (such as 1,2, propylene glycol) the sealing strength of the film is increased. Without being bound by theory, it is thought that this is due to the interaction of the poly(vinyl alcohol) hydroxyl groups with the different molecular sizes of plasticizers.

The mole ratio of the blend of plasticizers, such as a blend of glycerin and 1,2 propylene glycol, may be from 1:1 to 8:1, such as between 2:1 and 6:1, most preferably 4:1.

The water-soluble film may further comprise a plasticizer which is solid at room or ambient temperature.

By “solid at room or ambient temperature” it is meant that the melting point of the plasticizer at a pressure of 1 atmosphere is greater than about 20-25° C.

In a preferred embodiment thereof, said water-soluble film comprises less than 25 wt %, preferably less than 22 wt %, and more preferably less than 15 wt % of said at least one plasticizer.

In another preferred embodiment thereof, said water-soluble film comprises less than 25 wt %, preferably less than 22 wt %, and more preferably less than 15 wt % in total of all plasticizers.

In one embodiment, said inulin and/or said derivative thereof is a neutral uncharged molecule or a positively charged cationic molecule; preferably a positively charged cationic molecule.

In one embodiment, said water-soluble film comprises 0.15 to 20 wt %, preferably 3 to 15 wt %, and more preferably 3.5 to 13 wt % of said at least one inulin and/or of said at least one derivative thereof.

In one embodiment, said water-soluble film comprises 2 to 20 wt %, preferably 3 to 15 wt %, and more preferably 3.5 to 13 wt % in total of all inulins and derivatives thereof.

In one embodiment, said water-soluble film comprises at least two different poly(vinyl alcohol)s.

In a preferred embodiment thereof, one of the at least two different poly(vinyl alcohol)s has a weight average molecular weight of at least 50,000 g/mol while another one of the at least two different poly(vinyl alcohol)s has a weight average molecular weight of less than 50,000 g/mol.

In one embodiment, said water-soluble film comprises 50 to 90 wt %, preferably 65 to 80 wt %, and more preferably 70 to 75 wt % in total of all poly(vinyl alcohol)s.

The water-soluble film may comprise one layer or a plurality of layers.

The water-soluble film may further comprise one or more processing aids. Suitable processing aids include mono-, di-, tri-carboxylic acids/salts thereof, fatty acids such as stearic acid/salts thereof, mono-, di- or triglycerides/salts thereof, fumed silica and inorganic and organic pigments.

An anti-blocking agent may also be present in the film. Suitable anti-blocking agents include silica, talcum, zeolites and starch.

Further, the object of the present invention is also solved by a method for manufacturing of such an inventive water-soluble film comprising the following method steps:
i) Providing at least one poly(vinyl alcohol), at least one inulin and/or one derivative thereof; wherein said inulin and/or said derivative thereof is a neutral uncharged molecule, a positively charged cationic molecule or a negatively charged anionic molecule; and at least water as solvent;
ii) Mixing all components together to form a homogenous casting solution by stirring and heating the mixture up to a temperature of at least 40° C., preferably of at least 50° C., and more preferably of at least 60° C.;
iii) Casting a water-soluble film having a wet film thickness ranging from 200 to 1000 micrometer, preferably from 300 to 900 micrometer, and more preferably from 400 to 800 micrometer; and
iv) Drying the casted wet water-soluble film; in particular at room temperature for at least 8 hours; or in particular alternatively at elevated temperatures of at least 40° C., preferably of at least 50° C., and more preferably of at least 60° C. for at least 1 hour, preferably for at least 2 hours, and more preferably for at least 3 hours; for achieving a dry film thickness ranging from 50 to 150 micrometer, preferably from 70 to 100 micrometer, and more preferably from 75 to 90 micrometer.

Further, the object of the present invention is also solved by a dishwashing, preferably an automatic dishwashing, water-soluble container wherein said water-soluble container is made of such an inventive water-soluble film; and wherein said water-soluble container is at least partially filled with a dishwashing, preferably an automatic dishwashing, detergent composition.

In a preferred embodiment thereof, said water-soluble container comprises at least a first compartment and at least a, from the first compartment separated, second compartment; wherein said at least first compartment is at least partially filled with a dishwashing gel; and wherein said at least second compartment is at least partially filled with a dishwashing powder.

In an even more preferred embodiment thereof, said water-soluble container further comprises at least a third compartment separated from the first and the second compartment; wherein said at least third compartment is at least partially filled with a dishwashing liquid.

Alternatively, the object of the present invention is also solved by a laundry cleaning water-soluble container wherein said water-soluble container is made of such an inventive water-soluble film; and wherein said water-soluble container is at least partially filled with a laundry, preferably an automatic laundry, detergent composition.

In another alternative, the object of the present invention is also solved by a hard surface cleaning water-soluble container wherein said water-soluble container is made of such an inventive water-soluble film; and wherein said water-soluble container is at least partially filled with a hard surface cleaning detergent composition.

Additionally, the object of the present invention is also solved by making use of such an inventive water-soluble film for manufacturing a dishwashing, preferably an automatic dishwashing, water-soluble container by conducting a method as mentioned before.

The following non-limiting examples are provided to illustrate an embodiment of the present invention and to facilitate understanding of the invention but are not intended to limit the scope of the invention, which is defined by the claims appended hereto.

### EXPERIMENTAL PART

Biopolymers derived from inulin are utilized as new components in innovative PVOH formulas to partially replace glycerin and provide potential additional benefits. To be more specific, three inulins or derivatives thereof from Cosun are selected as presentative of neutral uncharged, positively charged cationic or negatively charged anionic inulins or derivatives thereof and tested, i.e. (natural) neutral inulin (CBP), hydroxypropyl trimonium modified cationic inulin (Quatin) and anionic carboxymethyl inulin (Carboxyline), respectively.

Several PVOH formulas were designed, films were prepared accordingly via solution casting method using film application device COATMASTER 510 Basic-G. Key parameters for capsule film material were tested, including water solubility, tensile strength, sealing strength and film forming assessment.

### Experiments

7 different water-soluble films comprising a poly(vinyl alcohol) were made, analyzed, and their properties compared:
1) Comparative film, based on water-soluble film comprising a poly(vinyl alcohol); and without comprising an inulin and/or a derivative thereof;
2-3) Water-soluble film comprising a low and a high level of cationic inulin derivative (Quatin 350, from Cosun) respectively.
4-5) Water-soluble film comprising a low and a high level of neutral inulin (CBP, from Cosun) respectively.
6-7) Water-soluble film comprising a low and a high level of anionic inulin derivative (Carboxyline 15-40 D, from Cosun) respectively.

The low level of inulins or derivatives thereof was determined as the lowest limit to bring benefits on glass substances. The high level ensured no build up effect of inulins or derivatives thereof in ADW, and enough plasticizers in PVOH for the properties as well.

JP-05 having 87.0-89.0 mol % degree of hydrolysis (DH) with viscosity 4.0-6.0 mPa·s of 4 wt % aqueous solution at 20° C., and JP-15 having 87.0-89.0 mol % degree of hydrolysis with viscosity 15.0-19.0 mPa·s of 4 wt % aqueous solution at 20° C. are PVOH resins from Shin-Etsu International Europe B.V.

### Preparation of Films:

The preparation of films was carried out according to the following procedure:
1) JP-05, JP-15 PVOH resins from Shin-Etsu and processing aids were homogenized to a granule mixture according to their ratio in the formula. 1 L 20 weight % stock solution thereof was prepared by dissolving the mixture in water under stirring and heating at 60° C.;
2) Inulins or derivatives thereof were weighted, and added into the stock solution, followed by stirring and heating at 60° C. to get a homogenous casting solution;
3) The solution was then cast using the film application device COATMASTER 510 Basic-G and a thickness-adjustable film applicator. Wet film thickness was usually set to 400-800 μm to achieve the dry thickness of 75-90 μm;
4) The casted film was dried either at room temperature overnight, or in the oven at 50-60° C. for at least 3 hours.

Formula 1-6 gave rise to compatible casting solutions, and therefore uniform and homogenous films. Formula 7 gave rise to a sol-gel mixture, and could not be cast to a film.

JP-05 has a weight average molecular weight of 40 000 g/mol, while JP-15 has a weight average molecular weight of 100 000 g/mol.

TABLE 1
Comparative and inventive formulations.

| Formula | 1 | 2 | 3 | 4 | 5 | 6 | 7 |
|---|---|---|---|---|---|---|---|
| Description | Comp. | Quatin | Quatin | CBP | CBP | Carboxyline | Carboxyline |
| | | low level | high level | low level | high level | low level | high level |
| JP-05 | 19.6 | 19.6 | 19.6 | 19.6 | 19.6 | 19.6 | 19.6 |
| JP-15 | 54.2 | 54.2 | 54.2 | 54.2 | 54.2 | 54.2 | 54.2 |
| Glycerin | 25 | 21.2 | 12.2 | 21.2 | 12.2 | 21.2 | 12.2 |
| Hydroxypropyl | / | 3.8 | 12.8 | / | / | / | / |
| trimonium | | | | | | | |
| Inulin | | | | | | | |
| Inulin | / | / | / | 3.8 | 12.8 | / | / |
| Carboxymethyl | / | / | / | / | / | 3.8 | 12.8 |
| Inulin | | | | | | | |
| Process aids | 1.2 | 1.2 | 1.2 | 1.2 | 1.2 | 1.2 | 1.2 |
| Sum (%) | 100 | 100 | 100 | 100 | 100 | 100 | 100 |

### Assessment of Films:

Films with a thickness of 90 μm were produced according to the aforementioned formula and procedure, following tests were carried out to evaluate the films as thermoforming foils for monodose products: i) Frame Dissolution; ii) Film mechanical properties; iii) Forming assessment.

### i) Frame Dissolution

Dissolution of films was tested according to the following method, and the results were shown in the following table 2.

A 1 L beaker is filled with 800 mL of deionized water at around 20° C. Water is under stirring and the bottom of the vortex is at level with the 600 mL mark of the beaker. A film sample of 45×37 mm is placed in a frame and then immersed in the water, with cross section orthogonal to the direction of water flow. The timepoints when the first hole appears and the whole film completely dissolves are recorded.

TABLE 2
Dissolution of PVOH films comprising an inulin or a derivative thereof

| Film | 1 | 2 | 3 | 4 | 5 | 6 | 7 |
|---|---|---|---|---|---|---|---|
| Description | Comp. | Quatin | Quatin | CBP | CBP | Carboxyline | Carboxyline |
| | | low level | high level | low level | high level | low level | high level |
| First hole/s | 65 ± 15 | 75 ± 5 | 74 ± 13 | 75 ± 8 | 79 ± 9 | 77 ± 3 | / |
| Complete | 3:52 ± 0:25 | 3:08 ± 0:20 | 2:45 ± 0:16 | 3:25 ± 0:32 | 2:59 ± 0:24 | 3:38 ± 0:25 | / |
| Dissolution/min | | | | | | | |

There is no data for film 7 since no representative film was successfully prepared according to formula 7. The experiments in table 2 show that the inventive films 1-6 show faster complete dissolution compared to benchmark film without an inulin or a derivative thereof.

### ii) Film Mechanical Properties

The tensile and sealing properties were then tested according to ISO 527-3 and ASTM F88 on a Zwicki-Line testing machine Z1.0. The results were shown in the following table 3 and table 4, respectively.

TABLE 3
Tensile properties of PVOH films comprising an inulin or a derivative thereof

| Film | 1 | 2 | 3 | 4 | 5 | 6 | 7 |
|---|---|---|---|---|---|---|---|
| Description | Comp. | Quatin | Quatin | CBP | CBP | Carboxyline | Carboxyline |
| | | low level | high level | low level | high level | low level | high level |
| Max. Force/N | 31.5 ± 6.3 | 50.2 ± 5.9 | 53.4 ± 4.9 | 35.3 ± 12.6 | 39.9 ± 3.4 | 42.9 ± 7.8 | / |
| Elongation/mm | 194 ± 26 | 137 ± 6 | 133 ± 9 | 129 ± 30 | 120 ± 8 | 130 ± 18 | / |

There is no data for film 7 since no representative film was successfully prepared according to formula 7. The experiments in table 3 show that the inventive films 2, 3, 5, 6 show enhanced tensile strength, especially film 2 and 3 with hydroxypropyl trimonium inulin compared to benchmark film without an inulin or a derivative thereof.

TABLE 4
Sealing properties of PVOH films comprising an inulin or a derivative thereof

| Film | 1 | 2 | 3 | 4 | 5 | 6 | 7 |
|---|---|---|---|---|---|---|---|
| Description | Comp. | Quatin | Quatin | CBP | CBP | Carboxyline | Carboxyline |
| | | low level | high level | low level | high level | low level | high level |
| Max. Force/N | 32.2 ± 1.5 | 35.2 ± 4.4 | 47.2 ± 6.5 | 35.1 ± 8.9 | 48.3 ± 0.8 | 31.9 ± 3.2 | / |
| Elongation/mm | 7.3 ± 0.6 | 5.6 ± 1.2 | 6.1 ± 1.4 | 7.9 ± 1.3 | 8.7 ± 1.6 | 6.9 ± 1.1 | / |

There is no data for film 7 since no representative film was successfully prepared according to formula 7. The experiments in table 4 show that the inventive films 3 and 5 show enhanced sealing strength compared to benchmark film without an inulin or a derivative thereof.

iii) Forming Assessment

Forming assessment of the films was tested according to the following method:

A water-soluble film was placed on a Wektor thermoforming kit with a mold having three individual cavities. Heat (120° C.) and vacuum (930 mbar) was applied to the film to assist forming into the cavities. A visual assessment was carried out for each individual cavity, wherein 0=best forming behavior and 8=worst forming behavior. The results were shown in the following table 5.

TABLE 5
Film Forming assessment

| Film | 1 | 2 | 3 | 4 | 5 | 6 | 7 |
|---|---|---|---|---|---|---|---|
| Description | Comp. | Quatin | Quatin | CBP | CBP | Carboxyline | Carboxyline |
| | | low level | high level | low level | high level | low level | high level |
| Cavity 1 | 0 | 0 | 0 | 0 | 0 | 0 | / |
| Cavity 2 | 0 | 1 | 2 | 2 | 2 | 2 | |
| Cavity 3 | 0 | 0 | 1 | 1 | 2 | 1 | / |

There is no data for film 7 since no representative film was successfully prepared according to formula 7. The experiments in table 5 show that the inventive films 2-6 show acceptable thermoforming processability.

As a general conclusion, it has to be highlighted that the inventive water-soluble films comprising at least an inulin or a derivative thereof show an improved dissolution and improved mechanical properties compared to comparative benchmark films, while their thermoforming processability is only slightly reduced.

Thus, it has been achieved to provide a water-soluble film having a higher bio-based content by the inulin or the derivative thereof. Thereby an active functional molecule could be incorporated in the film that does not negatively impact the film processing properties while the water-soluble film has gained an active sustainable component by the inulin or the derivative thereof.

### iv) Forming of a Water-Soluble Container

A dishwashing, preferably an automatic dishwashing, water-soluble container has been made of such a water-soluble film according to the present invention; wherein said water-soluble container is at least partially filled with a dishwashing, preferably an automatic dishwashing, detergent composition by the following method:

A first water-soluble film was placed on a Wektor thermoforming kit with a mold having at least one individual cavity. Preferred are two, and especially preferred three, individual cavities. Heat (120° C.) and vacuum (930 mbar) was applied to the first water-soluble film to assist forming into the cavities.

The heat and the vacuum have been applied in order to deform the first water-soluble film in such a way that the individual cavities are foreseen to generate the respective number of compartments for the final water-soluble container. Afterwards the at least one compartment generated by the at least one cavity is at least partially filled with a dishwashing, preferably an automatic dishwashing, detergent composition.

Afterwards, a second water-soluble film is placed on top of the first water-soluble film to close the at least one compartment. Therefore, heat is applied to seal the two water-soluble films to finally generate the water-soluble container, which is at least partially filled with a dishwashing, preferably an automatic dishwashing, detergent composition as a monodose article.

Alternatively, a laundry cleaning water-soluble container has been made of such a water-soluble film according to the present invention; and wherein said water-soluble container is at least partially filled with a laundry, preferably an automatic laundry, detergent composition.

Such a laundry detergent composition comprises a mixture of surfactants, pH adjusters, chelating agents, enzymes, fragrance, and/or dyes.

A preferred laundry detergent composition comprises glycerin, a C12-14 alcohol ethoxylate, sodium laureth sulfate, triethanolamine cocoate, propylene glycol, water, a fragrance, triethanolamine, citric acid, sodium diethylenetriamine, pentamethylene phosphonate, sodium sulfite, BHT, cellulase enzyme, hydrolyzed keratin, benzisothiazolinone, denatonium benzoate, and a dye.

Another preferred laundry detergent compositions are given by the following powder mixtures:

| | wt % based on total weight of the powder | | |
|---|---|---|---|
| Sodium Sulphate | 14.24 | 23.90 | 23.90 |
| Sodium Percarbonate | 45.00 | 45.00 | 55.00 |
| TAED | 4.32 | 2.76 | 5.52 |
| Oxygen transfer agent | 1.80 | 0.60 | |
| Sodium lauryl sulphate | 1.50 | | |
| Protease | 6.00 | 3.00 | 3.00 |
| Mannanase | 4.00 | | 1.00 |
| Lipase | 6.00 | | 1.00 |
| Amylase | 2.00 | 1.00 | 0.64 |
| PVP-VI | 0 | 1.50 | 1.50 |

Enzyme concentrations are of the enzymes as received, i.e., an enzyme preparation.

For the Protease preparation, it contained about 12 wt. % of the protease, based on the total weight of the protease preparation; this means that for a formulation having a powder comprising 6 wt. % of protease preparation, it had about 0.72 wt. % of protease as such, based on the total weight of the powder.

For the Mannanase preparation, it contained about 4 wt. % of the protease as such, based on the total weight of the mannanase preparation.

For the Lipase preparation, it contained about 7 wt. % of the lipase as such, based on the total weight of the lipase preparation.

For the Amylase preparation, it contained about 7 wt. % of the amylase as such, based on the total weight of the amylase preparation.

### Oxygen transfer agent=3-methyl-1,2-benzisothiazol-1,1-dioxide

PVP-VI: copolymer of 1-vinyl-2-pyrrolidone and 1-vinylimidazole with a molecular weight of about 70 000 g/mol.

In another alternative, a hard surface cleaning water-soluble container has been made of such a water-soluble film according to the present invention; and wherein said water-soluble container is at least partially filled with a hard surface cleaning detergent composition.

A preferred hard surface cleaning detergent composition comprises a mixture of surfactants, water-soluble organic solvents, pH adjusters, fragrance, and a dye, such as those disclosed in WO2004/020560 to Reckitt Benckiser Ltd, the contents of which are incorporated herein in its entirety by reference.

Another preferred hard surface cleaning detergent compositions are given by the following liquid mixtures:

wt % based on total weight

| Example | 35 | 42 | 61 |
|---|---|---|---|
| Quaternary Ammonium | 6.3* | 12.5** | 2.5*** |
| Linear C14-15 Alcohol with 7 | 6.9 | | |
| moles of ethylene oxide | | | |
| (Tomadol 45-7 from Tomah) | | | |
| C9-C11 Ethoxylated alcohol | | 14 | |
| with 6 moles of ethylene oxide | | | |
| (Tomadol 91-6 from Tomah) | | | |
| C9-C11 Ethoxylated alcohol | | | 7 |
| having about 6 ethoxy groups | | | |
| per molecule (Neodol 91-6 from | | | |
| Shell) | | | |
| PEG 600 | 73.49 | | |
| Dipropylene Glycol n-Butyl | 4.93 | 72 | |
| Ether | | | |
| Dipropylene Glycol Methyl | 4.93 | | |
| Ether | | | |
| Propylene Glycol n-Butyl Ether | | | 82.25 |
| Monoethanolamine | 1.97 | | 2 |
| Fragrance | 1.18 | 1.2 | 6.25 |
| Dye | 0.3 | 0.3 | |

*Bardac 208M = mixture of N,N-dialkyl(C8-10) N,N-dimethylammonium chloride and N-alkyl (C12-16) N,N-methyl-N-benzyl ammonium chloride (80% active, Lonza)
**BTC8358 = N-alkyl (50% C14, 40% C12, 10% C16) dimethyl benzyl ammonium chloride (80% active, Stepan)
***Barquat MS100 = N-Alkyl (C12-16)-N,N-dimethyl-N-benzyl ammonium chloride(Lonza)

The present invention thus addresses the problem of offering a sustainable, active, biopolymer based water soluble film comprising a poly(vinyl alcohol) and at the same time a reduced amount of plasticizer, such as glycerin, which has been substituted by an inulin or a derivative thereof.

It will be understood that the embodiments described herein are merely exemplary and that a person skilled in the art may make many variations and modifications without departing from the scope of the invention. All such variations and modifications, including those discussed above, are intended to be included within the scope of the invention as defined by the appended claims.

1. A water-soluble film comprising at least one poly(vinyl alcohol) characterized in that said water-soluble film further comprises at least one inulin and/or one derivative thereof; wherein said inulin and/or said derivative thereof is a neutral uncharged molecule, a positively charged cationic molecule or a negatively charged anionic molecule.

2. The water-soluble film according to claim 1 characterized in that said water-soluble film further comprises at least one plasticizer.

3. The water-soluble film according to claim 2 characterized in that said water-soluble film comprises less than 25 wt % of said at least one plasticizer.

4. The water-soluble film according to claim 2 characterized in that said water-soluble film comprises less than 25 wt % in total of all plasticizers.

5. The water-soluble film according to claim 1 characterized in that said inulin and/or said derivative thereof is a positively charged cationic molecule.

6. The water-soluble film according to claim 5 characterized in that said water-soluble film comprises 0.15 to 20 wt % of said at least one inulin and/or of said at least one derivative thereof.

7. The water-soluble film according to claim 5 characterized in that said water-soluble film comprises 2 to 20 wt % in total of all inulins and derivatives thereof.

8. The water-soluble film according to claim 1 characterized in that said water-soluble film comprises at least two different poly(vinyl alcohol)s.

9. The water-soluble film according to claim 8 characterized in that one of the at least two different poly(vinyl alcohol)s has a weight average molecular weight of at least 50,000 g/mol while another one of the at least two different poly(vinyl alcohol)s has a weight average molecular weight of less than 50,000 g/mol.

10. The water-soluble film according to claim 1 characterized in that said water-soluble film comprises 50 to 90 wt % in total of all poly(vinyl alcohol)s.

11. A method for manufacturing of a water-soluble film according to claim 1 comprising the following method steps:
i) Providing at least one poly(vinyl alcohol), at least one inulin and/or one derivative thereof; wherein said inulin and/or said derivative thereof is a neutral uncharged molecule, a positively charged cationic molecule or a negatively charged anionic molecule; and at least water as solvent;
ii) Mixing all components together to form a homogenous casting solution by stirring and heating the mixture up to a temperature of at least 40° C.;
iii) Casting a water-soluble film having a wet film thickness ranging from 200 to 1000 micrometer; and
iv) Drying the casted wet water-soluble film for achieving a dry film thickness ranging from 50 to 150 micrometer.

12. A dishwashing water-soluble container characterized in that said water-soluble container is made of a water-soluble film according to claim 1; and wherein said water-soluble container is at least partially filled with a dishwashing detergent composition.

13. The dishwashing water-soluble container according to claim 12 characterized in that said water-soluble container comprises at least a first compartment and at least a, from the first compartment separated, second compartment; wherein said at least first compartment is at least partially filled with a dishwashing gel; and wherein said at least second compartment is at least partially filled with a dishwashing powder.

14. The dishwashing water-soluble container according to claim 13 characterized in that said water-soluble container further comprises at least a third compartment separated from the first and the second compartment; wherein said at least third compartment is at least partially filled with a dishwashing liquid.

15. Use of a water-soluble film according to claim 1 for manufacturing a dishwashing water-soluble container by conducting a method according to claim 11.

16. The water-soluble film according to claim 8 characterized in that said water-soluble film comprises 50 to 90 wt % in total of all poly(vinyl alcohol)s.

17. The method for manufacturing of a water-soluble film according to claim 11, wherein in method step iv):
the drying is executed at room temperature for at least 8 hours; or
the drying is executed at elevated temperatures of at least 40° C. for at least 1 hour.

18. A method for manufacturing of a water-soluble film according to claim 8 comprising the following method steps:
i) Providing at least one poly(vinyl alcohol), at least one inulin and/or one derivative thereof; wherein said inulin and/or said derivative thereof is a neutral uncharged molecule, a positively charged cationic molecule or a negatively charged anionic molecule; and at least water as solvent;
ii) Mixing all components together to form a homogenous casting solution by stirring and heating the mixture up to a temperature of at least 40° C.;
iii) Casting a water-soluble film having a wet film thickness ranging from 200 to 1000 micrometer; and
iv) Drying the casted wet water-soluble film for achieving a dry film thickness ranging from 50 to 150 micrometer.

19. The method for manufacturing of a water-soluble film according to claim 18, wherein in method step iv):
the drying is executed at room temperature for at least 8 hours; or
the drying is executed at elevated temperatures of at least 40° C. for at least 1 hour.

20. A dishwashing water-soluble container characterized in that said water-soluble container is made of a water-soluble film according to claim 8; and wherein said water-soluble container is at least partially filled with a dishwashing detergent composition.
